(19) United States
(12) Patent Application Publication
(10) Pub. No.: US 2016/0263800 A1
(43) Pub. Date: Sep. 15, 2016

(54) METHOD OF MOLDING A COMPOSITE SHEET

(71) Applicant: FORD GLOBAL TECHNOLOGIES, LLC, Dearborn, MI (US)

(72) Inventors: Jeffery N. Conley, Belleville, MI (US); Charles Alan Rocco, Milford, MI (US)

(21) Appl. No.: 14/645,453

(22) Filed: Mar. 12, 2015

(51) Int. Cl. B29C 45/40; B29C 45/72

(52) U.S. Cl. CPC B29C 45/40; B29C 45/7207; B29L 2009/00

(57) ABSTRACT

A method is provided for molding a composite sheet in an injection molding press including a female mold tool and a cooperating male mold tool. The method includes the steps of loading the composite sheet into an open mold, positioning a heating element between the composite sheet and the female mold tool to preheat the composite sheet and a cavity of the female mold tool and removing the heating element and closing the mold.

### TECHNICAL FIELD

This document relates generally to molding methods and, more particularly, to a heated composite sheet insert molding process.

### BACKGROUND

In accordance with state-of-the-art composite sheet molding processes, a composite sheet is heated in an oven that sits adjacent to the injection molding process. The heated sheet is then transferred from the oven and positioned on locating pins in the injection mold either by hand, a robot or other mechanism. The holes in the composite sheet are preformed in the hard sheet. The mold is then closed and plastic is injected onto the composite sheet. The mold is then opened, the molded part is then removed and excess material is trimmed from the finished part.

This state-of-the-art process is subject to a number of issues. First, since the composite sheet is hot when positioned on the locating pins, the sheet has a tendency to sag or stretch when being moved from the oven into the injection molding press. This may cause thin spots and/or holes in the sheet. Further, the sagging or stretching may also cause the locating holes to elongate or deform thereby making proper location of the composite sheet in the press difficult.

Second, it takes some time for the composite sheet to be transferred from the oven into the injection molding press. During this transfer process, the composite sheet starts to cool. By the time the composite sheet is loaded into the injection molding press and the press is ready to close, the composite sheet may cool to the point that it is difficult to form to the shape of the mold thereby causing a part defect.

This document relates to a new improved method of molding a composite sheet in an injection molding press that addresses and successfully overcomes these two potential issues.

### SUMMARY

In accordance with the purposes and benefits described herein, a method is provided for molding a composite sheet in an injection molding press including a female mold tool and a cooperating male mold tool. That method may be broadly described as comprising the steps of: (a) loading the composite sheet into an open mold, (b) positioning a heating element between the composite sheet and the female mold tool to preheat the composite sheet and a cavity of the female mold tool; and (c) removing the heating element and closing the mold. In one possible embodiment, that method further includes holding the composite sheet on locating pins in the mold. Further, the method includes maintaining the composite sheet a predetermined distance from the female mold tool upon loading into the open mold in order to maintain desired clearance for the heating element.

Still further, in one possible embodiment, the method includes using springs on the locating pins in order to maintain the desired clearance. Still more specifically, the method includes completing the loading of the composite sheet into the open mold while the composite sheet is at room temperature. Thus the composite sheet is not soft and will not stretch thereby eliminating any potential thin spots and holes. This also prevents the punched locating holes in the composite sheet from being distorted due to stretching, elongation or deformation of the sheet during loading. That is, the punched holes are maintained of the highest integrity and allow the composite sheet to be properly positioned over the locating pins in the mold when loading the composite sheet into the open mold.

As the mold is closed, the springs that maintain the composite sheet a predetermined distance from the female mold tool for clearance of the heating element, are compressed into recesses in the female mold tool so that they will not interfere with the molding of the composite sheet into an injected molded part of proper shape.

Still further, the method includes injecting plastic onto one side of the composite sheet while the mold is closed. More specifically, the method includes injecting plastic through an injection pathway in the male mold tool onto one side of the composite sheet while the mold is closed. Subsequently, the method includes opening the mold and removing an injected molded part from the open mold. This is followed by trimming excess composite material from the injected molded parts removed from the mold. That trimming may be completed by any appropriate means including, for example, die cutting, laser cutting and water jet cutting.

In accordance with an additional aspect, an injection molding press is provided with a female mold tool and a cooperating male mold tool. A plurality of locator pins project from the female mold tool. A plurality of clearance springs are also provided. One clearance spring is received over each of the locator pins. These function to hold a composite sheet in a desired position a desired distance from the face of the female mold tool.

Still further, the female mold tool includes a plurality of recesses for receiving and holding the plurality of clearance springs around the plurality of locator pins. In addition, the molding press includes a heating element that is inserted between the composite sheet and the female mold tool to preheat the composite sheet and the face of the female mold tool including the mold cavity prior to molding. A plurality of bores in the male mold tool receive the plurality of locator pins when the male and female mold tools are closed together.

In the following description, there are shown and described several preferred embodiments of the molding method. As it should be realized, the molding method is capable of other, different embodiments and its several details are capable of modification in various, obvious aspects all without departing from the molding method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the molding method and together with the description serve to explain certain principles thereof. In the drawing figures:

FIG. 1 illustrates the open mold of the injection molding press ready to be loaded with a composite sheet.

FIG. 2 illustrates the open mold with a composite sheet positioned on locating pins extending from the female mold tool and maintained a predetermined distance from the female mold tool by springs received around those pins.

FIG. 3 illustrates the step of positioning a heating element between the composite sheet and the female mold tool to preheat the composite sheet and a cavity of the female mold prior to the closing of the mold.

FIG. 4 illustrates the closing of the mold and the injecting of plastic through an injection pathway in the male mold tool onto one side of the composite sheet while the mold is closed.

FIG. 5 illustrates the opening of the mold following the molding of the injected molded part from the composite sheet.

FIG. 6 illustrates the trimming of excess composite material from the injected molded part removed from the mold.

Reference will now be made in detail to the present preferred embodiments of the molding method, examples of which are illustrated in the accompanying drawing figures.

### DETAILED DESCRIPTION

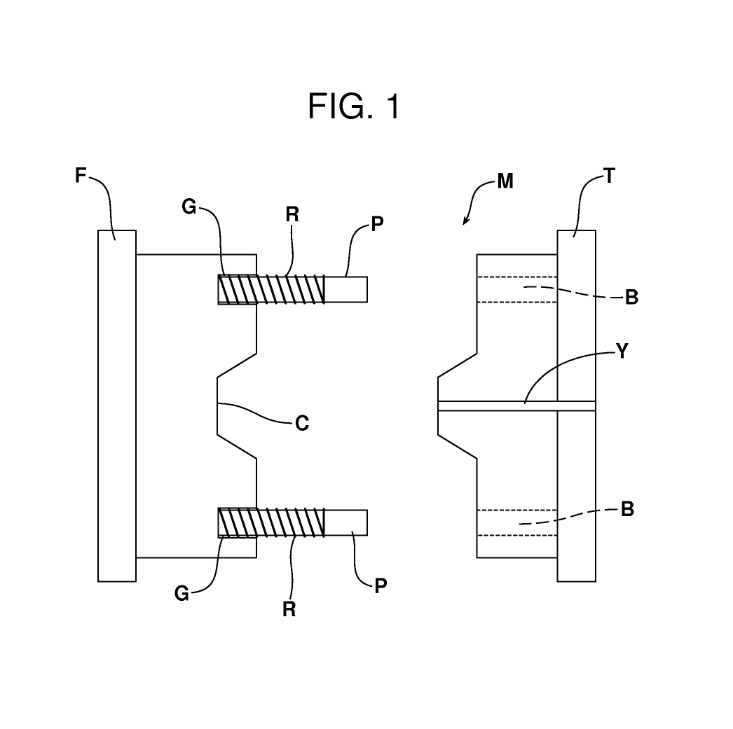

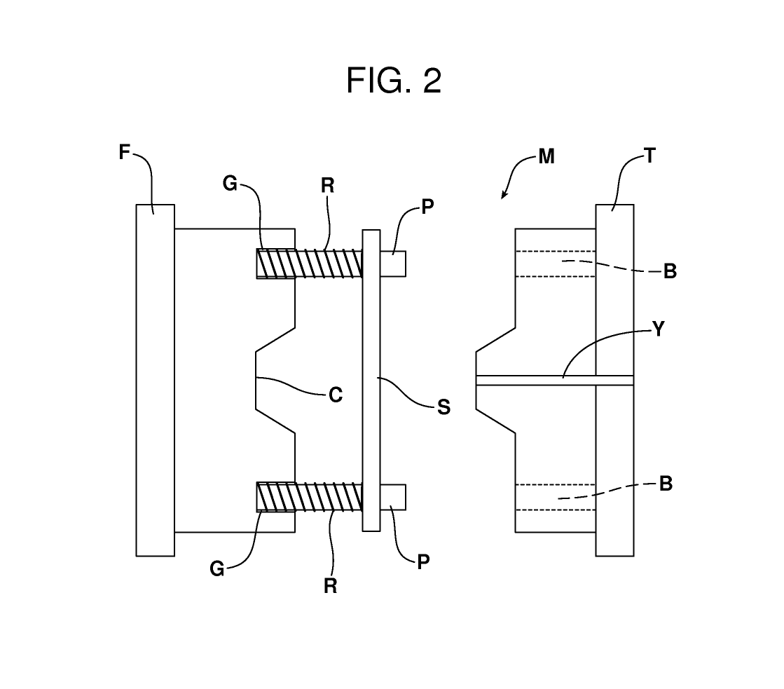

Reference is now made to FIGS. 1-6, which illustrate an injection molding press and a method of molding a composite sheet S in an injection molding process wherein the injection molding press M includes a female mold tool F and a cooperating male mold tool T. FIG. 1 illustrates the molding press M in an open position wherein the female mold tool F is separated from the male mold tool T. The molding method includes the step of loading the composite sheet S into the open mold M (FIG. 2). More specifically, punched holes in the composite sheet S are positioned over locating pins P that project from the face of the female mold tool F. As illustrated, the composite sheet S is held on the locating pins P while springs R that extend concentrically around the pins P maintain the composite sheet S a predetermined distance from the female mold tool F. This is done in order to maintain a desired clearance for a heating element H.

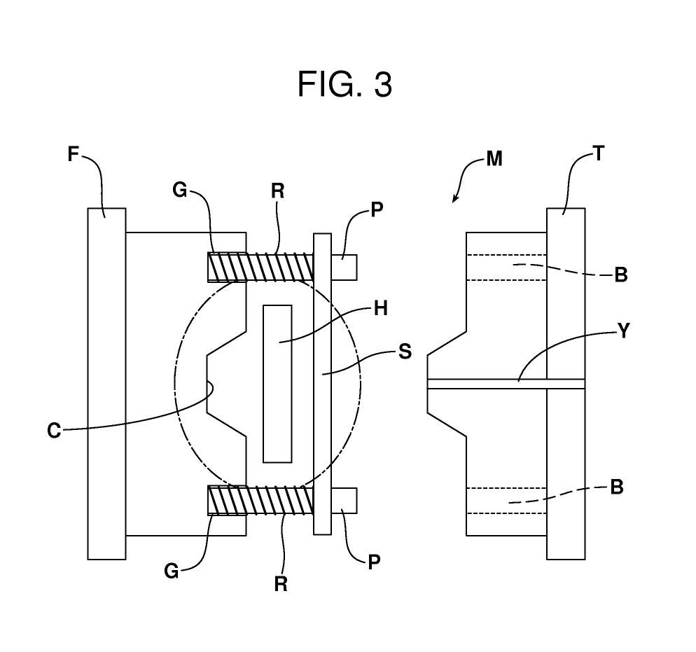

As illustrated in FIG. 3, the method includes positioning the heating element H between the composite sheet S and the female mold tool F in order to preheat the composite sheet and a cavity C in the female mold tool F. As should be appreciated, the concave walls of the cavity C serve to concentrate the heat and more efficiently and effectively preheat the female mold tool F for molding the composite sheet S into a desired part.

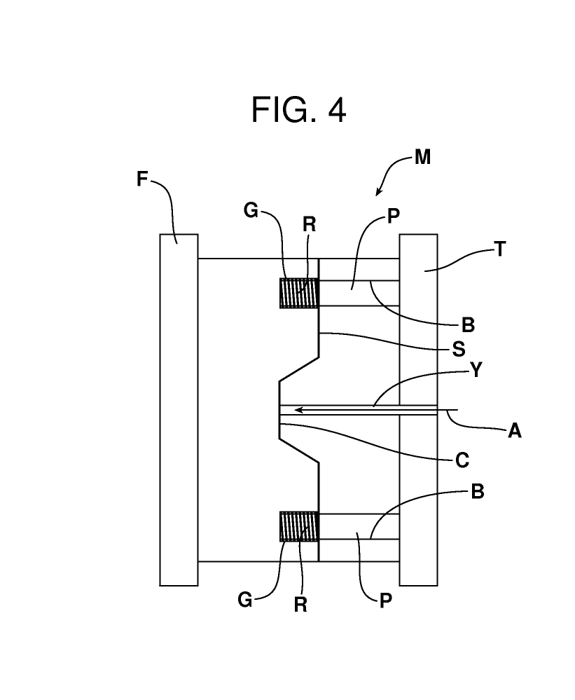

Next the method includes the step of removing the heating element H from the molding press M and closing the mold (see FIG. 4). As the female mold tool F and male mold tool T are pressed together, the springs R compress into recesses G in the female mold tool F and the pins P are received in the bores B of the male mold tool T. Thus, the springs R and pins P in no way interfere with the shaping and molding of the composite sheet S by the female and male mold tools F, T.

As further illustrated in FIG. 4, plastic is injected onto one side of the composite sheet S through the injection pathway Y formed in the male mold tool T onto one side of the composite sheet while the mold is closed. Note action arrow A.

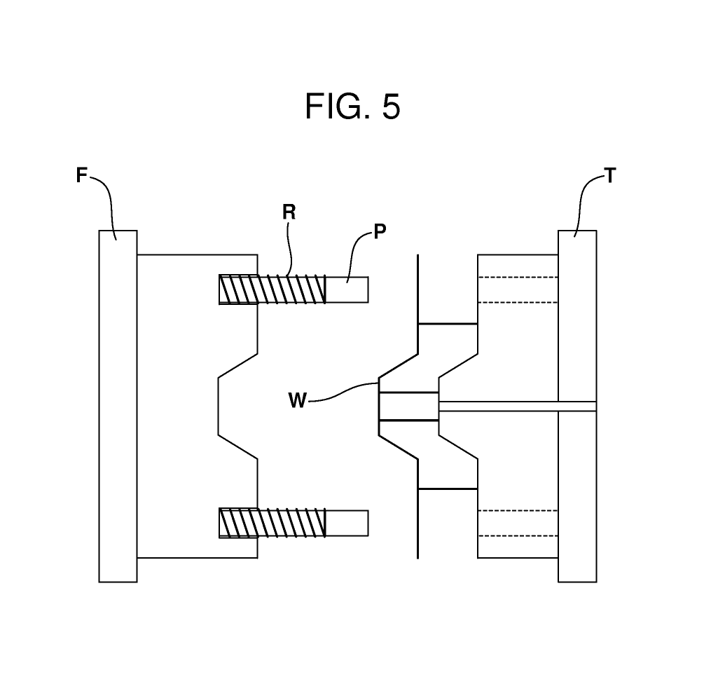

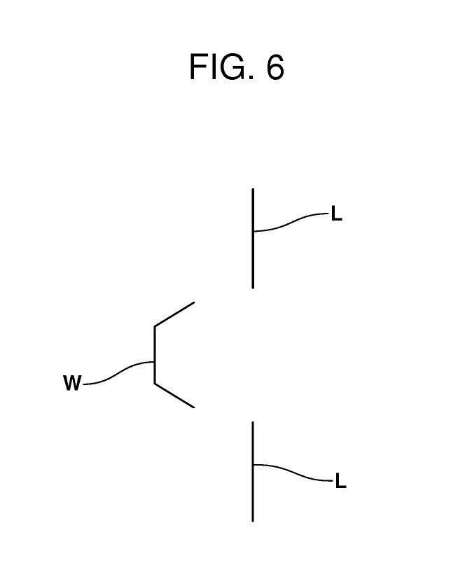

As illustrated in FIG. 5, this step is followed by the opening of the molding press M and the removing of the injected molded part W from the open mold. As illustrated in FIG. 6, this step is followed by the trimming of excess composite L from the molded part W after it is removed from the mold M. This trimming may be completed in accordance with any appropriate process including, but not limited to, die cutting, laser cutting and water jet cutting.

As should be appreciated, the composite sheet S utilized in the method is made from a thermoplastic material. That sheet S may also be reinforced with carbon fibers, fiberglass, carbon nanotubes or other reinforcing materials utilized in the art. Significantly, the composite sheet S is loaded into the mold M at room temperature so that the composite sheet S does not stretch and the locating holes punched in the sheet are not distorted in any manner. This ensures that the composite sheet S is properly aligned for molding when the punched holes are positioned over the locating pins P.

Once the composite sheet S is positioned on the pins P, the springs R maintain the composite sheet a desired predetermined distance from the female mold tool F. That distance not only allows easy insertion and removal of the heating element H between the composite sheet S and the female mold tool F but also provides the desired proximity for optimum preheating of both the composite sheet S and the female mold tool F including, particularly, the cavity C in the female mold tool F. That cavity C has a concave surface that focuses the heat for maximum efficiency. In contrast, it should be appreciated that the male mold tool T has a convex surface that tends to disperse rather than concentrate the heat from the heating element H.

In summary, numerous benefits and advantages are provided by the molding method described in this document. Advantageously, cycle times are decreased and the complexity of the process is reduced. More specifically, the present method eliminates the need for a separate preheating oven as well as the need for a robot or person to transfer the heated composite sheet S from such an oven to the mold M. The elimination of the transfer of a heated composite sheet S into the mold provides a number of very significant advantages. First it eliminates any tendency for the heated composite sheet S to stretch and sag, which can lead to thin areas or actual holes in the composite sheet. Of course, this stretching or sagging may also serve to distort the locator holes punched in the sheet which could potentially lead to misalignment of the composite sheet S in the mold and the molding of a defective part.

In addition, preheating of the composite sheet S within the mold M in accordance with the present method functions to eliminate heat losses associated with the sheet being transferred into the mold M from an oven in accordance with the prior art process.

Advantageously, the loading of the composite sheet S at room temperature using punched holes as taught in the present method allows for hand loading for shorter or prototype runs thereby eliminating the need for a robot to handle hot composite sheet materials.

Advantageously, in the present method, the heating element H heats both the composite sheet S and the mold M so that the sheet forms a lot easier and the plastic flows more efficiently and effectively versus trying to form the part in a mold that has not been preheated as with the prior art process. Further, it should be appreciated that the composite sheet S is a lot hotter when the mold M closes as compared to an oven heated sheet from the prior art process. This allows the composite sheet S to form to the mold M better for more accuracy. Further, the present method is characterized by a decreased cycle time as a robot can quickly load the sheet, the heating element H may then be quickly inserted into the mold M, the mold and sheet may then be quickly heated, the heating element H may then be quickly removed from the mold and then the mold may then be quickly closed without any significant loss of heat as characteristic of the prior art process that utilizes a separate oven to preheat the sheet that is then transferred to the mold M.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method of molding a composite sheet in an injection molding press including a female mold tool and a cooperating male mold tool, comprising:
loading the composite sheet into an open mold;
positioning a heating element between said composite sheet and the female mold tool to preheat the composite sheet and a cavity of the female mold tool;
removing said heating element; and
closing said mold.

2. The method of claim 1, including holding said composite sheet on locating pins in the mold.

3. The method of claim 2, including maintaining the composite sheet a predetermined distance from said female mold tool upon loading into the open mold in order to maintain said desired clearance for the heating element.

4. The method of claim 3, including using springs on said locating pins in order to maintain said desired clearance.

5. The method of claim 4, including injecting plastic onto one side of the composite sheet while said mold is closed.

6. The method of claim 4, including injecting plastic through an injection pathway in the male mold tool onto one side of the composite sheet while said mold is closed.

7. The method of claim 6, including compressing the springs into recesses in the female mold tool when the mold is closed.

8. The method of claim 7, including opening the mold.

9. The method of claim 8, including removing an injected molded part from the open mold.

10. The method of claim 9, including trimming excess composite material from the injected molded part removed from the mold.

11. The method of claim 9, including trimming excess composite material from the injected molded part removed from the mold by die cutting.

12. The method of claim 9, including trimming excess composite material from the injected molded part removed from the mold by laser cutting.

13. The method of claim 9, including trimming excess composite material from the injected molded part removed from the mold by water jet cutting.

14. The method of claim 1, including completing the loading of the composite sheet into the open mold while the composite sheet is at room temperature.

15. The method of claim 14, including positioning punched holes in the composite sheet over locating pins in the mold when loading the composite sheet into the open mold.

16. An injection molding press, comprising:
a female mold tool;
a cooperating male mold tool;
a plurality of locator pins projecting from said female mold tool; and
a plurality of clearance springs, one spring of said plurality of clearance springs being received concentrically around each of said plurality of locator pins for holding a composite sheet a desired distance from a face of said female mold tool.

17. The molding press of claim 16, wherein said female mold tool includes a plurality of recesses for receiving and holding said plurality of clearance springs around said plurality of locator pins.

18. The molding press of claim 17, further including a heating element that is inserted between said composite sheet held on said plurality of locator pins and said face of said female mold tool.

19. The molding press of claim 18, wherein said face includes a mold cavity.

20. The molding press of claim 19, further including a plurality of bores in said male mold tool aligned with and receiving said plurality of locator pins when said female mold tool and said male mold tool are closed together.
